(19) United States
(12) Patent Application Publication
(10) Pub. No.: US 2006/0130150 A1
(43) Pub. Date: Jun. 15, 2006

(54) Context-sensitive authorization

(76) Inventors: Daniel C. Garza-Gonzalez, Cypress, TX (US); Craig A. Boeker, Spring, TX (US); George M. Williams JR., Fort Collins, CO (US)

Correspondence Address: HEWLETT-PACKARD COMPANY;Intellectual Property Administration, P. O. Box 272400, Fort Collins, CO, 80527-2400, US

(21) Appl. No.: 11/008,496

(22) Filed: Dec. 9, 2004

(51) Int. Cl. H04L 9/32

(52) U.S. Cl. 726/28

(57) ABSTRACT

Systems, methodologies, media, and other embodiments associated with context-sensitive rights-varying authorization are described. One exemplary system embodiment includes a logic configured to establish an authorization space. The example system may also include a logic configured to identify an access mechanism employed to interact with a resource and an effective rights logic configured to establish an effective set of access rights for an interaction with the resource based, at least in part, on the access mechanism employed to interact with the resource.

### BACKGROUND

Computer security has long involved user authentication, user authorization, and access control. Authentication has typically been concerned with verifying a user identity through, for example, a username/password credentialing mechanism. Authorization has typically been concerned with determining rights and privileges granted to a user. For example, a certain user may have a certain level of privileges associated with their identity. Authorization typically occurs after submitted credentials (e.g., username/password) have been authenticated and validated. Access control has typically been concerned with protected resources. Access control typically occurs after authentication and authorization. Thus, when a particular identity attempts to access a resource, the privileges associated with the particular identity may be compared against the privileges required to access the resource.

More generally, in an authorization space, a user may be authenticated and then authorized to possess a set of access rights for a set of resources. Typically this authorization operates globally within an authorization space and is applied in a consistent, context-insensitive manner. For example, a user may be authorized to have read/write access to a file and may be granted read/write access to that file regardless of the context in which the user accesses the file even if it makes no sense to have read/write access in a certain context. By way of illustration, when using an editor to access a file, it may make sense to have read/write access, but when using a backup utility to access that same file it may only make sense to have read access, otherwise a backup file may be overwritten, with potentially catastrophic results.

Thus, in conventional systems, user rights are typically fixed when the user is authenticated. To employ a different set of rights, the user must typically change their identity and have that identity re-authenticated.

### BRIEF DESCRIPTION OF THE DRAWINGS

The accompanying drawings, which are incorporated in and constitute a part of the specification, illustrate various example systems, methods, and so on, that illustrate various example embodiments of aspects of the invention. It will be appreciated that the illustrated element boundaries (e.g., boxes, groups of boxes, or other shapes) in the figures represent one example of the boundaries. One of ordinary skill in the art will appreciate that one element may be designed as multiple elements or that multiple elements may be designed as one element. An element shown as an internal component of another element may be implemented as an external component and vice versa. Furthermore, elements may not be drawn to scale.

FIG. 1 illustrates a system that includes a system configuration tool interacting with a context-sensitive authorization logic.

FIG. 2 illustrates an example method that facilitates varying authorizations defined in a global space based on an operating context without requiring a user to change identities.

FIG. 3 illustrates an example context-sensitive authorization apparatus.

FIG. 4 illustrates another example method that facilitates varying authorizations defined in a global space based on an operating context without requiring a user to change identities.

FIG. 5 illustrates another example context-sensitive authorization apparatus.

FIG. 6 illustrates an example computing environment in which example systems and methods illustrated herein may operate.

FIG. 7 illustrates an example application programming interface (API).

FIG. 8 illustrates another example method that facilitates varying authorizations defined in a global space based on an operating context without requiring a user to change identities.

### DETAILED DESCRIPTION

This application describes example systems, methods, and so on associated with context-sensitive authorization and varying user rights without requiring a user to change identity. In the examples, tools and rights may be defined with access mechanisms. Thus, the context in which a user attempts to assert a right(s) (e.g., which access mechanism is employed) may determine, at least in part, an effective set of rights available to the user. For example, in a first context, when a user employs a first tool and thus a first access mechanism, a user may be restricted to a subset of their total set of rights while in a second context, when the user employs a second tool and thus a second access mechanism, the user may have available their entire set of rights. In the examples, the user may employ the same authenticated identity with the different tools in the different contexts. Therefore, a different authenticated identity is not required to vary user rights.

The following includes definitions of selected terms employed herein. The definitions include various examples and/or forms of components that fall within the scope of a term and that may be used for implementation. The examples are not intended to be limiting. Both singular and plural forms of terms may be within the definitions.

As used herein, the term “authorization space” refers to a set of rules that define what a subject (e.g., person) can do with respect to a set of objects (e.g., resources). In one example authorization space, a user may be authorized with a set of access rights associated with a set of tools and/or resources.

As used in this application, the term “computer component” refers to a computer-related entity like hardware, firmware, software, a combination thereof, or software in execution. For example, a computer component can be, but is not limited to being, a process running on a processor, a processor, an object, an executable, a thread of execution, a program, and a computer. By way of illustration, both an application running on a server and the server can be computer components. One or more computer components can reside within a process and/or thread of execution and a computer component can be localized on one computer and/or distributed between two or more computers.

“Computer-readable medium”, as used herein, refers to a medium that participates in directly or indirectly providing signals, instructions and/or data. A computer-readable medium may take forms, including, but not limited to, non-volatile media, volatile media, and transmission media. Non-volatile media may include, for example, optical or magnetic disks, and so on. Volatile media may include, for example, optical or magnetic disks, dynamic memory and the like. Transmission media may include coaxial cables, copper wire, fiber optic cables, and the like. Transmission media can also take the form of electromagnetic radiation, like that generated during radio-wave and infra-red data communications, or take the form of one or more groups of signals. Common forms of a computer-readable medium include, but are not limited to, a floppy disk, a flexible disk, a hard disk, a magnetic tape, other magnetic media, a CD-ROM, other optical media, punch cards, paper tape, other physical media with patterns of holes, a RAM, a ROM, an EPROM, a FLASH-EPROM, or other memory chip or card, a memory stick, a carrier wave/pulse, and other media from which a computer, a processor or other electronic device can read. Signals used to propagate instructions or other software over a network, like the Internet, can be considered a “computer-readable medium.”

“Data store”, as used herein, refers to a physical and/or logical entity that can store data. A data store may be, for example, a database, a table, a file, a list, a queue, a heap, a memory, a register, and so on. A data store may reside in one logical and/or physical entity and/or may be distributed between two or more logical and/or physical entities.

“Logic”, as used herein, includes but is not limited to hardware, firmware, software and/or combinations of each to perform a function(s) or an action(s), and/or to cause a function or action from another logic, method, and/or system. For example, based on a desired application or needs, logic may include a software controlled microprocessor, discrete logic like an application specific integrated circuit (ASIC), a programmed logic device, a memory device containing instructions, or the like. Logic may include one or more gates, combinations of gates, or other circuit components. Logic may also be fully embodied as software. Where multiple logical logics are described, it may be possible to incorporate the multiple logical logics into one physical logic. Similarly, where a single logical logic is described, it may be possible to distribute that single logical logic between multiple physical logics.

An “operable connection”, or a connection by which entities are “operably connected”, is one in which signals, physical communications, and/or logical communications may be sent and/or received. Typically, an operable connection includes a physical interface, an electrical interface, and/or a data interface, but it is to be noted that an operable connection may include differing combinations of these or other types of connections sufficient to allow operable control. For example, two entities can be operably connected by being able to communicate signals to each other directly or through one or more intermediate entities like a processor, operating system, a logic, software, or other entity. Logical and/or physical communication channels can be used to create an operable connection.

“Signal”, as used herein, includes but is not limited to one or more electrical or optical signals, analog or digital signals, data, one or more computer or processor instructions, messages, a bit or bit stream, or other means that can be received, transmitted and/or detected.

“Software”, as used herein, includes but is not limited to, one or more computer or processor instructions that can be read, interpreted, compiled, and/or executed and that cause a computer, processor, or other electronic device to perform functions, actions and/or behave in a desired manner. The instructions may be embodied in various forms like routines, algorithms, modules, methods, threads, and/or programs including separate applications or code from dynamically and/or statically linked libraries. Software may also be implemented in a variety of executable and/or loadable forms including, but not limited to, a stand-alone program, a function call (local and/or remote), a servelet, an applet, instructions stored in a memory, part of an operating system or other types of executable instructions. It will be appreciated by one of ordinary skill in the art that the form of software may depend, for example, on requirements of a desired application, the environment in which it runs, and/or the desires of a designer/programmer or the like. It will also be appreciated that computer-readable and/or executable instructions can be located in one logic and/or distributed between two or more communicating, co-operating, and/or parallel processing logics and thus can be loaded and/or executed in serial, parallel, massively parallel and other manners.

Suitable software for implementing the various components of the example systems and methods described herein may be produced using programming languages and tools like Java, Pascal, C#, C++, C, CGI, Perl, SQL, APIs, SDKs, assembly, firmware, microcode, and/or other languages and tools. Software, whether an entire system or a component of a system, may be embodied as an article of manufacture and maintained or provided as part of a computer-readable medium as defined previously. Another form of the software may include signals that transmit program code of the software to a recipient over a network or other communication medium. Thus, in one example, a computer-readable medium has a form of signals that represent the software/firmware as it is downloaded from a web server to a user. In another example, the computer-readable medium has a form of the software/firmware as it is maintained on the web server. Other forms may also be used.

“User”, as used herein, includes but is not limited to one or more persons, software, computers or other devices, or combinations of these.

Authorization mechanisms exist in computer applications, operating systems, and so on (collectively, “applications”). These applications may interact with different resources that require different access rights. Typically, these applications have not distinguished between different access or usage models for interacting with resources. This consistent (e.g., context-insensitive) approach may affect factors like the flexibility, usefulness, and ease of use for such applications. For example, a context-insensitive approach does not consider operating contexts where applying a restricted subset of authorizations for a user may be desired and/or useful without requiring a user re-authentication.

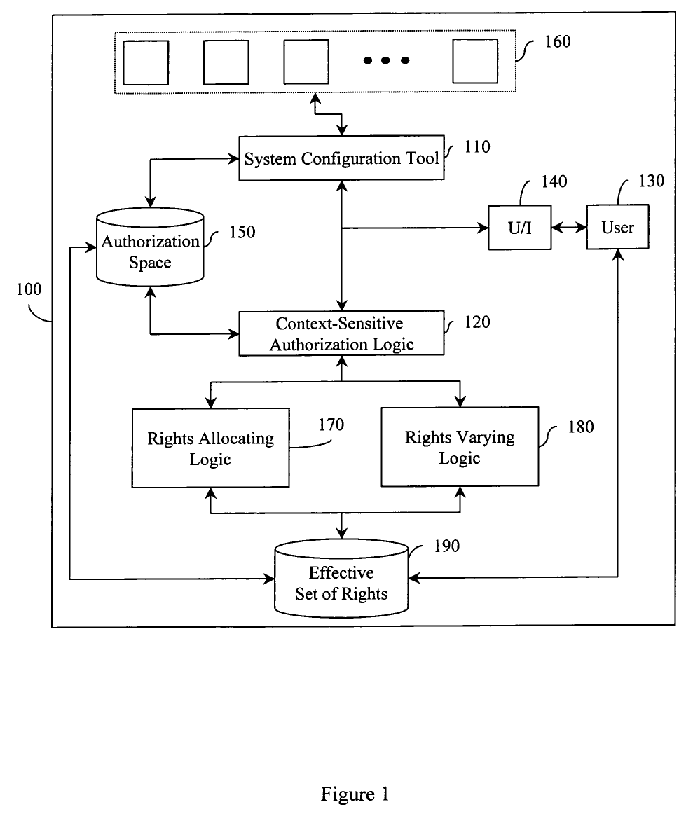

FIG. 1 illustrates a system 100 that includes a system configuration tool 110 that is configured to interact with a context-sensitive authorization logic 120. The context-sensitive authorization logic 120 may implement systems and/or methods that facilitate determining (e.g., restricting) an effective set of rights 190 that are available to a user 130 to assert when accessing a resource. The effective set of rights 190 may be derived, for example, from an authorization space 150 and may be based, for example, on a usage mechanism employed by user 130.

In one example, two types of usage mechanisms are available, a global access mechanism and a direct access mechanism. The global access mechanism may allow user 130 to assert the total sum of their available rights when accessing a resource. This does not mean that user 130 will automatically be able to access a resource, only that the all the rights available for user 130 will be considered when determining whether to grant access to a resource. The direct access mechanism may be employed when user 130 chooses a specific right or group of rights to assert against a specific resource. When the direct access mechanism is selected, a limited set of rights instead of the entire set of rights will be evaluated to determine whether to grant access to a resource.

While two usage mechanisms are described, it is to be appreciated that in other examples different usage mechanisms may be available. Additionally, while two rights accessing techniques are described, it is to be appreciated that in other examples different rights accessing techniques may be available. Furthermore, while a one-to-one relationship between a usage mechanism and a rights accessing technique are described, it is to be appreciated that in some examples relationships other than the example one-to-one relationship may be employed. In one example, user 130 may explicitly select an access mechanism through, for example, a user interface 140. In another example, user 130 may implicitly (e.g., transparently) select an access mechanism based, for example, on an application selected to interact with a resource.

The system configuration tool 110 may facilitate managing a set of computer systems. The systems may be arranged, for example, in a local area network (LAN). Individual computer systems may include components like disk drives, processors, memories, network access points, and so on. The system configuration tool 110 may therefore consider the systems, the components in the systems, and connections between components and/or systems as resources. Thus, as used herein, “resource” refers to a computer component protected by an access rights scheme.

The system configuration tool 110 may include and/or interact with a set of tools 160 like computer-executable programs for interacting with the resources. While computer-executable programs are described, it is to be appreciated that the tools may take other forms like applets, objects, routines, procedures, and so on. Thus, as used herein, “tool” refers to a logic configured to interact with a resource. A tool may be, for example, a computer-executable program. In different examples, a tool may be located on a single machine and/or may be distributed between two or more machines. Similarly, in different examples, a tool may be local or remote to a user. The tools may include, for example, a system startup tool, a disk drive configuration tool, and so on. An example system startup tool may be associated with a first (e.g., more comprehensive) set of rights while an example disk drive configuration tool may be associated with a second (e.g., more restrictive) set of rights. Thus, the tool that user 130 chooses to interact with a resource may determine, at least in part, the effective set of rights 190 available to user 130 during the interaction. By way of illustration, if user 130 has a large set of rights and uses the system startup tool, user 130 may have the entire set of rights available to assert for accessing (e.g., shutting down) a resource. But when user 130 uses the disk drive configuration tool, the effective rights available to assert for accessing (e.g., reconfiguring) the disk drive may be restricted down to a smaller set of rights than those available when using the system startup tool. Note that application selection rather than authenticated identity determined the effective set of rights 190 for user 130. Thus, in this example, the selection mechanism was implicit in the choice of tools.

Rights may also be organized to facilitate explicit mechanism selections. For example, an administrator-level login right may be available for an authenticated user 130 to interact with a resource (e.g., computer system) available through system configuration tool 110. Similarly, a guest-level login right may be available for an authenticated user 130 to interact with a resource (e.g., computer component) available through the system configuration tool 110. The administrator-level login may employ the total set of rights available to the authenticated user 130 while the guest-level login may restrict down the set of rights available to the authenticated user 130. Which login tool the authenticated user 130 selects may therefore determine, at least in part, the access rights available to the authenticated user 130. In this administrator-level/guest-level login right example, the authenticated user 130 used an explicit selection mechanism to affect their effective set of rights 190 by manually selecting a login tool to employ.

Rights and tools may be defined for an authorization space 150 using, for example, key/value pairs stored in an XML (extensible markup language) file. While an XML file is described, it is to be appreciated that rights and tools may be defined using other mechanisms and may be recorded using data stored in other formats. In the XML example, an entry for a “right” attribute may be included in a definition. For example, the name-value pair provided below defines an attribute “login-right” and provides a value “administrator” for that attribute.

<attribute name=“login-right”>administrator</attribute>

Rights of different types may be provided. Thus, it is to be appreciated that rights are not limited to login rights. Additionally, the value for a right may take different forms. In one example, the value for a right may itself include a name-value pair or multiple name-value pairs. For example, the record below includes a name-value pair that defines an attribute “login-right” and includes two name-value pairs for values for that attribute.

<attribute name=“login-right”>app1=administrator; app2=guest</attribute>

Other attributes may be associated with tools and rights and may specify, for example, how a tool or right may be accessed. For example, the records below identify a right “login-right”, a value for that right, an attribute “menu-path” that specifies how the right may be accessed, and a value for the menu-path attribute.

<attribute name=“login-right”>guest</attribute>

<attribute name=“menu-path”>System, Guest Login</attribute>

The example records described above may now be examined with respect to system 100. For example, while user 130 is working with system configuration tool 110, user 130 may attempt to access a resource for which user 130 has a set of rights. User 130 may access the resource in a generic fashion defined within system configuration tool 110 like clicking on a generic web-link. This may cause a global access mechanism to be implicitly selected and thus the entire set of rights available to user 130 may be available to assert when interacting with a resource. In one example, choosing the tool initiated through the web-link may lead to the rights being summarized as:

login-right=administrator,

login-right:app1=administrator,

login-right:app2=guest

Note that in this summary, login-right=guest is superseded by login-right=administrator and thus is not included. While a single right being superseded is illustrated, it is to be appreciated that in other examples including a greater number of rights, more than one right may be removed from a summary because it is superseded and thus superfluous.

In another example, user 130 may access the resource using a direct access method like one defined with the tool or right. For example, user 130 may access a resource using a direct access method defined for an application menu (e.g., System, Guest Login menu). Thus, user 130 would have the effective set of rights 190 restricted to those defined with the access definition (e.g., login-right=guest).

In one example, the system configuration tool 110 may be a web-based application. The web-based application 110 may interact with authorization logic 120, which may be configured to facilitate dynamically varying, on a per interaction basis, access rights users may assert when interacting with computer resources. The web-based application 110 may interact with computer resource accessing tools 160 that are configured to facilitate performing operations on a computer resource. In one example, each of the computer resource accessing tools 160 may have associated access methods that determine rights and/or right selection methods.

As described above, system 100 may include a user interface 140 that facilitates user 130 selecting a tool from the computer resource accessing tools 160 for interacting with a resource. User interface 140 may also facilitate user 130 selecting an action to perform on a computer resource using the selected computer resource accessing tool. The computer resource accessing tools 160 may include, for example, a resource viewer, a topography viewer, a resource start/stop tool, a resource maintenance tool, a resource configuration tool, and so on.

Context-sensitive authorization logic 120 may include a rights allocating logic 170 that is configured to allocate a first set of rights to user 130 based on an authenticated identity for user 130. The first set of rights may be derived from information stored in the authorization space 150. The context-sensitive authorization logic 120 may also include a rights varying logic 180 that is configured to produce a second set of rights (e.g., effective set of rights 190) from the first set of rights on a per action basis. Producing the second set of rights may depend, at least in part, on a tool selected from the computer resource accessing tools 160 and the action to be performed using the selected computer resource accessing tool. The rights varying logic 180 may produce the second set of rights without requiring user 130 to be re-authenticated. Thus, user 130 may retain their identity through different interactions with different resources using different members of the tools 150.

Some portions of the detailed descriptions that follow are presented in terms of algorithms and symbolic representations of operations on data bits within a memory. These algorithmic descriptions and representations are the means used by those skilled in the art to convey the substance of their work to others. An algorithm is here, and generally, conceived to be a sequence of operations that produce a result. The operations may include physical manipulations of physical quantities. Usually, though not necessarily, the physical quantities take the form of electrical or magnetic signals capable of being stored, transferred, combined, compared, and otherwise manipulated in a logic and the like.

It has proven convenient at times, principally for reasons of common usage, to refer to these signals as bits, values, elements, symbols, characters, terms, numbers, or the like. It should be borne in mind, however, that these and similar terms are to be associated with the appropriate physical quantities and are merely convenient labels applied to these quantities. Unless specifically stated otherwise, it is appreciated that throughout the description, terms like processing, computing, calculating, determining, displaying, or the like, refer to actions and processes of a computer system, logic, processor, or similar electronic device that manipulates and transforms data represented as physical (electronic) quantities.

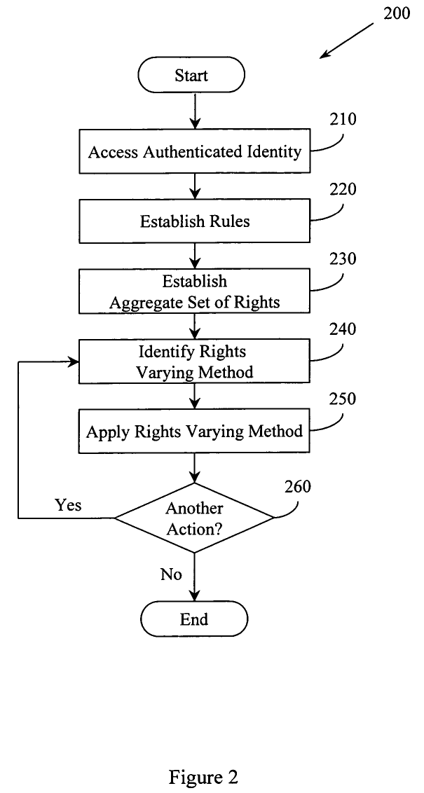

Example methods may be better appreciated with reference to the flow diagrams of FIGS. 2, 4, and 8. While for purposes of simplicity of explanation, the illustrated methodologies are shown and described as a series of blocks, it is to be appreciated that the methodologies are not limited by the order of the blocks, as some blocks can occur in different orders and/or concurrently with other blocks from that shown and described. Moreover, less than all the illustrated blocks may be required to implement an example methodology. Furthermore, additional and/or alternative methodologies can employ additional, not illustrated blocks.

In the flow diagrams, blocks denote “processing blocks” that may be implemented with logic. The processing blocks may represent a method step and/or an apparatus element for performing the method step. A flow diagram does not depict syntax for any particular programming language, methodology, or style (e.g., procedural, object-oriented). Rather, a flow diagram illustrates functional information one skilled in the art may employ to develop logic to perform the illustrated processing. It will be appreciated that in some examples, program elements like temporary variables, routine loops, and so on, are not shown. It will be further appreciated that electronic and software applications may involve dynamic and flexible processes so that the illustrated blocks can be performed in other sequences that are different from those shown and/or that blocks may be combined or separated into multiple components. It will be appreciated that the processes may be implemented using various programming approaches like machine language, procedural, object oriented and/or artificial intelligence techniques.

FIG. 2 illustrates a method 200 that facilitates dynamically varying authorizations defined in a global space without requiring a user to employ different identities. Thus, in one example, method 200 may facilitate dynamically varying access rights users may assert when interacting with computer resources. Method 200 may include, at 210, accessing an authenticated user identity. Authenticating a user identity may include, for example, validating credentials like a username/password pair. In one example, method 200 may include performing the authentication while in the illustrated example, method 200 begins after a user has been authenticated.

Method 200 may also include, at 220, establishing a set of rules that describe a set of interactions the user may have with respect to a set of computer resources. This set of rules may be referred to, for example, as an authorization space. In one example, the content of the set of rules may depend, at least in part, on the authenticated identity for the user. For example, a first user may have a first set of potential rules from which the set of rules may be formed while a second user may have a second set of potential rules from which the set of rules may be formed.

In one example, establishing the set of rules may include storing name-value pairs in XML records. The name-value pairs may be configured to identify items like, a computer-executable tool, a right associated with a computer-executable tool, a rights varying method associated with a computer-executable tool, and so on. While XML records are described, it is to be appreciated that in other examples, other data types, file formats, and so on may be employed.

Method 200 may also include, at 230, establishing an aggregate set of rights the user has available to assert against a set of computer resources. The aggregate set of rights may be derived from the set of rules established at 220. In one example, the aggregate set of rights depends, at least in part, on the authenticated identity for the user. For example, a first user may be assigned a first set of rights based on their identity while a second user may be assigned a second set of rights based on their identity.

In one example, establishing the aggregate set of rights may include selecting a value(s) from a name-value pair(s) stored in an XML record(s). Establishing the aggregate set of rights may also include summarizing the selected value(s) into a set of values and selectively eliminating a superceded value(s) from the set. After superceded values have been removed, establishing the aggregate set of rights may also include arranging the set of values into new name-value pairs in new XML records. Again, while XML records are described, it is to be appreciated that in other examples, non-XML records and data formats may be employed.

With the aggregate set of rights established for the authenticated user, method 200 may then repeat, on a per interaction basis, performing several actions. For example, at 240, in response to the authenticated user selecting a computer-executable tool to interact with a chosen computer resource, method 200 may include identifying a rights varying method associated with the selected computer-executable tool. The rights varying method may be, for example, a sum of rights method associated with a global access mechanism, a subset of rights method associated with a direct access mechanism, and so on. The access mechanism (e.g., global, direct) may be related to the computer-executable tool in, for example, the set of rules.

Method 200 may also include, at 250, applying the rights varying method identified at 240 to the aggregate set of rights established at 230 to determine which access rights are available to the user to assert while interacting with the chosen computer resource using the selected computer-executable tool. In one example, applying the rights varying method to the aggregate set of rights may include selecting an aggregated value(s) from name-value pairs stored at 230 in the new XML records and selectively eliminating an aggregated value(s) based on the rights varying method. A more restrictive rights varying method may lead to the user having a smaller effective set of rights while a more global or inclusive rights varying method may lead to a larger effective set of rights.

At 260 a determination may be made concerning whether to process another user action. If the determination at 260 is Yes, then processing may return to 240, otherwise processing may conclude.

While FIG. 2 illustrates various actions occurring in serial, it is to be appreciated that various actions illustrated in FIG. 2 could occur substantially in parallel. By way of illustration, a first process could authenticate a user identity. Similarly, a second process could establish a set of rules, while a third process could establish an aggregate set of rights, a fourth process could identify a rights varying method, and a fifth process could apply the rights varying method. While five processes are described, it is to be appreciated that a greater and/or lesser number of processes could be employed and that lightweight processes, regular processes, threads, and other approaches could be employed. It is to be appreciated that other example methods may, in some cases, also include actions that occur substantially in parallel.

In one example, computer-executable methodologies are implemented as processor executable instructions and/or operations provided on a computer-readable medium. Thus, in one example, a computer-readable medium may store processor executable instructions operable to perform a method for dynamically varying access rights users may assert when interacting with computer resources without requiring user identity changes. The method may include accessing an authenticated identity for a user and establishing a set of rules that describe a set of interactions the user may have with respect to a set of computer resources. The method may also include establishing, from the set of rules, an aggregate set of rights the user has available to assert against the set of computer resources. With the rules and aggregate set of rights established, the method may then, on a per interaction basis, respond to the user selecting a computer-executable tool to interact with a chosen computer resource by identifying a rights varying method associated with the selected computer-executable tool. After identifying the rights varying method, the method may then apply the rights varying method to the aggregate set of rights to determine which access rights are available to the user for interacting with the chosen computer resource using the selected computer-executable tool. While the above method is described being provided on a computer-readable medium, it is to be appreciated that other example methods described herein can also be provided on a computer-readable medium.

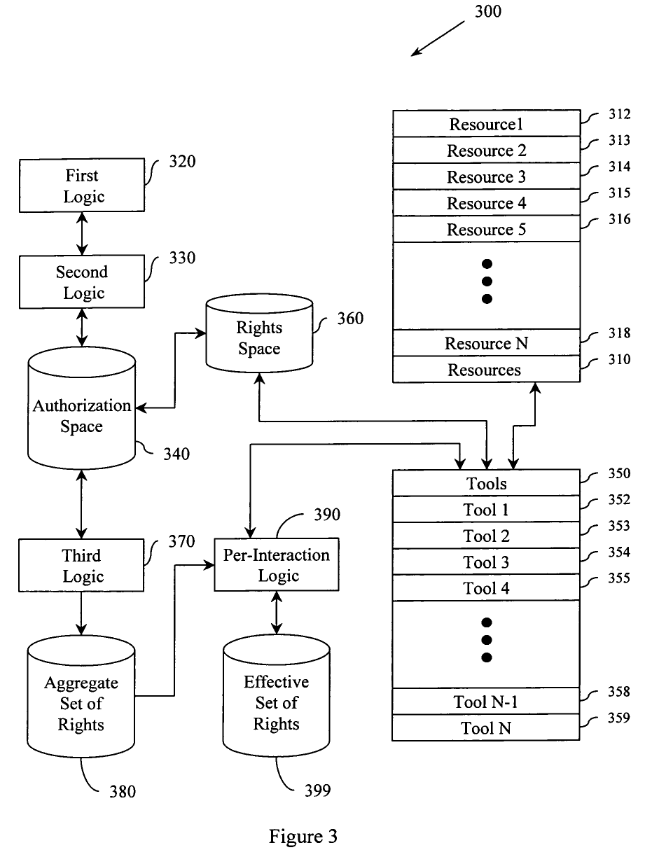

FIG. 3 illustrates a system 300 that facilitates one authenticated user asserting different sets of access rights during different interactions with computer resources 310 while maintaining their single authenticated identity. System 300 may include a first logic 320 that is configured to access an authenticated identity for a user. In some examples, logic 320 may be configured to perform the authentication. Authenticating an identity may include, for example, validating user credentials.

System 300 may also include a second logic 330 that is configured to create an authorization space 340. The authorization space 340 may include, for example, a set of rules that are configured to facilitate defining interactions the user may have with the access-controlled resources 310 that are accessible through tools 350 characterized in a rights space 360. The composition of the authorization space 340 may depend, at least in part, on the identity of the user. In one example, the second logic 330 creates the authorization space 340 by storing records configured to record relationships between items like a user, a computer-executable tool, a right, and a resource. While records are described, it is to be appreciated that in some examples other data structures may be employed to store the authorization space 340.

System 300 may also include a third logic 370 that is configured to create an aggregate set of rights 380 that the user has available to assert against the access-controlled computer resources 310. The aggregate set of rights 380 may be derived from information available in authorization space 340. In one example, the third logic 370 creates the aggregate set of rights 380 by retrieving a relationship data from the records stored in the authorization space 340, summarizing relationships in the relationship data, and eliminating superfluous relationships in the summarized relationships. With the reduced relationship data available, the third logic 370 may then store records to record the aggregate set of rights 380. While records are described, it is to be appreciated that in some examples other data structures may be employed to store the aggregate set of rights 380.

System 300 may also include a per-interaction logic 390 that is configured to identify a tool (e.g., computer-executable program) selected by the user to interact with one of the access-controlled computer resources 310. The per-interaction logic 390 may, for example, identify a rights varying method associated with the identified computer-executable tool and then apply the rights varying method to the aggregate set of rights 380 to produce an effective set of rights 399 for an interaction. In one example, the per-interaction logic 390 applies the rights varying method by retrieving an aggregate rights data from the aggregate set of rights 380 and then selectively removing an item(s) from the aggregate rights data to create the effective set of rights 399 for an interaction.

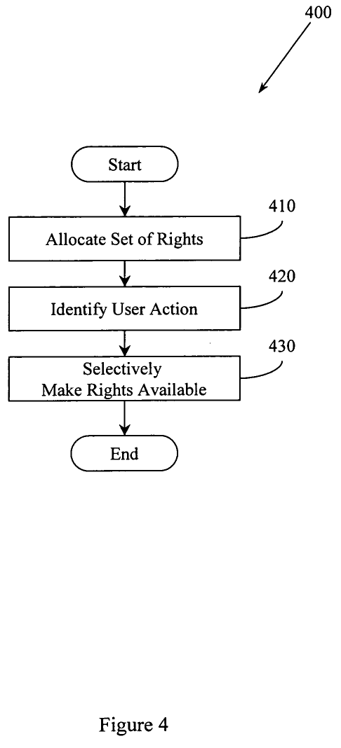

FIG. 4 illustrates a method 400 that facilitates varying authorizations defined in a global space based on an operating context without requiring a user to employ different identities. Method 400 may include, at 410, allocating a set of rights to a user. Which rights are allocated may depend, at least in part, on an authenticated identity for the user.

Method 400 may also include, at 420, identifying an action performed by the user. The action may directed to a rights-protected resource that is accessible through members of a set of tools that are associated with a rights environment. In one example, method 400 may also include, (not illustrated) establishing the rights environment by storing one or more XML records in a data store. The rights environment may be configured to facilitate characterizing, at least in part, a tool (e.g., computer executable program, object, applet) that is configured to facilitate user access to a rights-protected resource. Characterizing the tool may include, for example, defining a rights-controlling access mechanism associated with the tool. The access mechanism may be, for example, a global access mechanism, a direct access mechanism, and so on. While XML records are described, it is to be appreciated that in some examples other data structures may be employed to establish the rights environment.

Method 400 may also include, at 430, selectively making available to the user, for the purpose of accessing the rights-protected resource, selected members of the set of rights allocated to the user at 410. Which rights are made available at 430 may depend, at least in part, on the action performed by the user. Different sets of rights may be made available to the user for different interactions without requiring the user to be re-authenticated. Thus, authorizations defined in a global space may be varied for a user while maintaining the authenticated identity for the user.

In one example, the action performed by the user determines which of a global access mechanism and a direct access mechanism is applied to the set of rights allocated to the user at 410. Thus, the action performed by the user contributes to determining which members of the set of rights allocated to the user at 410 will be made available to the user at 430. By way of illustration, the global access mechanism may be associated with a non-restricting method for determining which members of the set of rights allocated to the user at 410 will be made available to the user at 430. Similarly, the direct access mechanism may be associated with a restricting method for determining which members of the set of rights allocated to the user at 410 will be made available to the user at 430. The non-restricting method or the restricting method may be applied to the set of rights allocated to the user on a per access basis to determine whether a member of the set of rights allocated to the user is made available to the user at 430 for an access to a rights-protected resource. This facilitates authorizations defined in a global space to be varied for a user while maintaining the authenticated identity for the user.

To illustrate the per access approach to rights assignment, method 400 may, for subsequent actions performed by the user, identify the subsequent action, identify a tool the user wants to use to perform the action, and identify a rights-protected resource accessible through the tool. Method 400 may then, for the subsequent action, selectively make available to the user, for the purpose of accessing the rights-protected resource, members of the set of rights allocated to the user at 410. Which rights are made available has been demonstrated to depend on the subsequent action undertaken by the user without requiring a re-authenticated identity for the user.

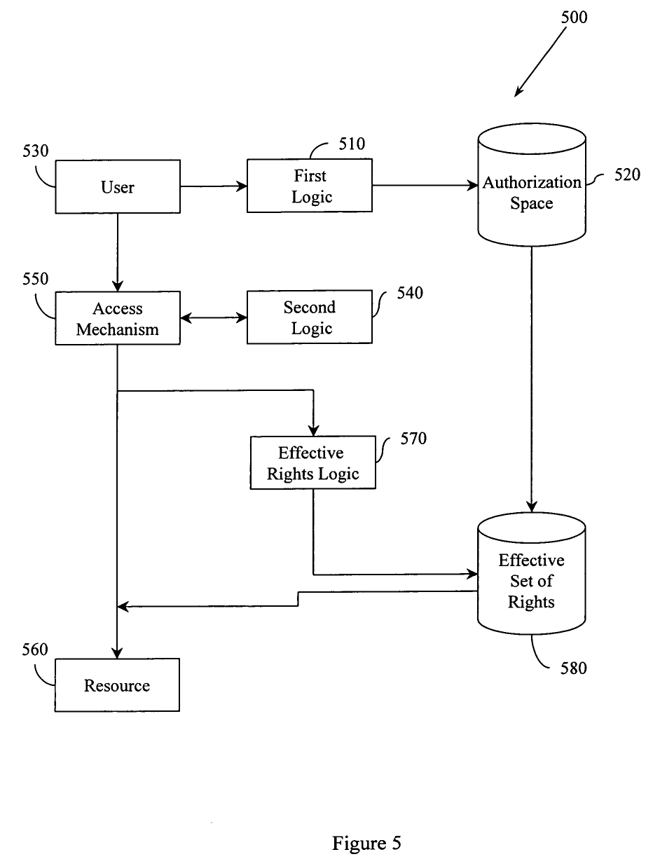

FIG. 5 illustrates a system 500 that facilitates varying user access rights on a per-interaction basis without requiring user re-authentication. System 500 includes a first logic 510 that is configured to establish an authorization space 520 for a user 530. The contents of the authorization space 520 may depend, at least in part, on a user identity. In one example an authorization space 520 may be built from data that facilitates defining actions users may take with respect to resources accessible through tools characterized in a rights space.

System 500 may also include a second logic 540 that is configured to identify an access mechanism employed by the user to access a resource 560. The second logic 540 may be configured to determine whether the user employed a global access mechanism or a direct access mechanism to access the resource 560. The global access mechanism and the direct access mechanism may be chosen, for example, by either an implicit choice (e.g., mechanism associated with tool) and an explicit choice (e.g., mechanism directly selectable). In one example, the global access mechanism may be associated with a sum of rights method for determining the effective set of rights 580. Similarly, the direct access mechanism may be associated with a subset of rights method for determining the effective set of rights 580. The sum of rights method may place all rights available to user 530 in the effective set of rights 580. However, the subset of rights method may place less than all the rights available to user 530 in the effective set of rights 580. While a one-to-one correspondence between the direct mechanism to subset of rights method and between the global mechanism to sum of rights method is described, it is to be appreciated that in other examples this one-to-one correspondence may not apply and that other access mechanisms and/or rights varying methods may be available and related in different manners.

System 500 may also include an effective rights logic 570 that is configured to establish the effective set of rights 580 for user 530 based, at least in part, on authorization space 520 and on the access mechanism 550 employed by user 530 to access resource 560. The effective rights logic 570 may also be configured to manipulate the effective set of rights 580 while maintaining the user 530 identity.

In some examples, system 500 may also include, (not illustrated) a rights logic that is configured to access a rights space from which the authorization space 520 for the user 530 can be established. The rights space may include a set of data that is configured to facilitate characterizing tools (e.g., computer executable programs, objects, applets) for accessing resources (e.g., computers, computer components, connections). Characterizing a tool may include, for example, identifying an access mechanism 550 associated with the tool.

The rights logic may be configured to establish the rights space by storing data as rights records in a data store. A rights record may include, for example, a name-value pair arranged in an XML record. The name-value pair may be configured to identify items like tools, rights associated with tools, access methods associated with tools, and so on.

The effective rights logic 570 may apply the sum of rights or subset of rights method to data stored in the authorization space 520 to make the effective set of rights 580. The effective set of rights 580 may not be a fixed set of rights. It may be varied, for example, on a per access or per interaction basis. Note that the effective set of rights logic 570 may create different effective sets of rights 580 for user 530 without requiring user 530 to change their identity and without being re-authenticated.

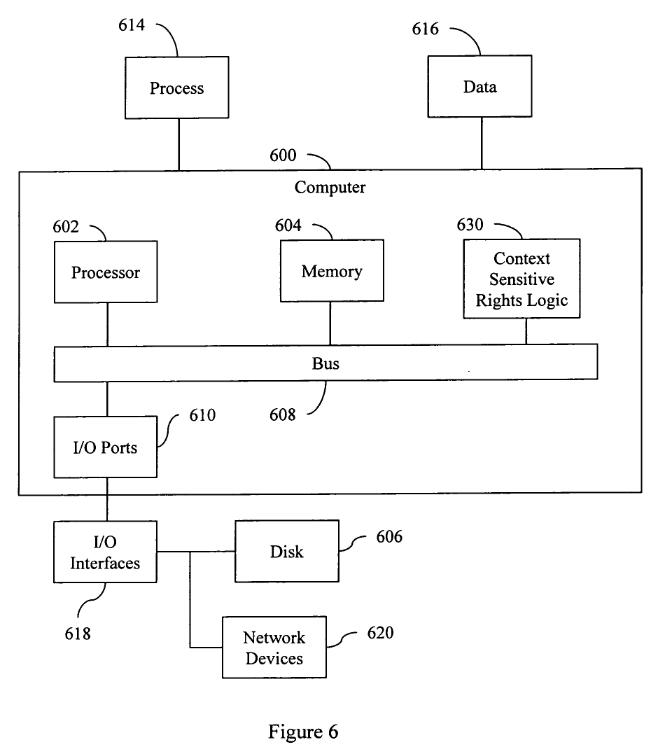

FIG. 6 illustrates a computer 600 that includes a processor 602, a memory 604, and input/output ports 610 operably connected by a bus 608. In one example, the computer 600 may include a context-sensitive rights logic 630 that is configured to facilitate dynamically varying access rights users may assert when interacting with computer resources. Thus, the context-sensitive rights logic 630, whether implemented in computer 600 as hardware, firmware, software, and/or a combination thereof may provide means for accessing an authorization space associated with a credentialed user identity, means for identifying a context determining user action performed by the credentialed user identity, and means for selectively making available to the credentialed user identity a set of access rights applicable to resources associated with the authorization space. Which rights are made available may depend, at least in part, on the context determining user action. Additionally, the set of access rights may be varied on a per access basis without requiring the credentialed user identity to be manipulated.

The processor 602 can be a variety of various processors including dual microprocessor and other multi-processor architectures. The memory 604 can include volatile memory and/or non-volatile memory. The non-volatile memory can include, but is not limited to, ROM, PROM, EPROM, EEPROM, and the like. Volatile memory can include, for example, RAM, synchronous RAM (SRAM), dynamic RAM (DRAM), synchronous DRAM (SDRAM), double data rate SDRAM (DDR SDRAM), and direct RAM bus RAM (DRRAM).

A disk 606 may be operably connected to the computer 600 via, for example, an input/output interface (e.g., card, device) 618 and an input/output port 610. The disk 606 can include, but is not limited to, devices like a magnetic disk drive, a solid state disk drive, a floppy disk drive, a tape drive, a Zip drive, a flash memory card, and/or a memory stick. Furthermore, the disk 606 can include optical drives like a CD-ROM, a CD recordable drive (CD-R drive), a CD rewriteable drive (CD-RW drive), and/or a digital video ROM drive (DVD ROM). The memory 604 can store processes 614 and/or data 616, for example. The disk 606 and/or memory 604 can store an operating system that controls and allocates resources of the computer 600.

The bus 608 can be a single internal bus interconnect architecture and/or other bus or mesh architectures. While a single bus is illustrated, it is to be appreciated that computer 600 may communicate with various devices, logics, and peripherals using other busses that are not illustrated (e.g., PCIE, SATA, Infiniband, 1394, USB, Ethernet). The bus 608 can be of a variety of types including, but not limited to, a memory bus or memory controller, a peripheral bus or external bus, a crossbar switch, and/or a local bus. The local bus can be of varieties including, but not limited to, an industrial standard architecture (ISA) bus, a microchannel architecture (MSA) bus, an extended ISA (EISA) bus, a peripheral component interconnect (PCI) bus, a universal serial (USB) bus, and a small computer systems interface (SCSI) bus.

The computer 600 may interact with input/output devices via i/o interfaces 618 and input/output ports 610. Input/output devices can include, but are not limited to, a keyboard, a microphone, a pointing and selection device, cameras, video cards, displays, disk 606, network devices 620, and the like. The input/output ports 610 can include but are not limited to, serial ports, parallel ports, and USB ports.

The computer 600 can operate in a network environment and thus may be connected to network devices 620 via the i/o interfaces 618, and/or the i/o ports 610. Through the network devices 620, the computer 600 may interact with a network. Through the network, the computer 600 may be logically connected to remote computers. The networks with which the computer 600 may interact include, but are not limited to, a local area network (LAN), a wide area network (WAN), and other networks. The network devices 620 can connect to LAN technologies including, but not limited to, fiber distributed data interface (FDDI), copper distributed data interface (CDDI), Ethernet (IEEE 802.3), token ring (IEEE 802.5), wireless communication (IEEE 802.11), Bluetooth (IEEE 802.15.1), Zigbee (IEEE 802.15.4) and the like. Similarly, the network devices 620 can connect to WAN technologies including, but not limited to, point to point links, circuit switching networks like integrated services digital networks (ISDN), packet switching networks, and digital subscriber lines (DSL). While individual network types are described, it is to be appreciated that communications via, over, and/or through a network may include combinations and mixtures of communications.

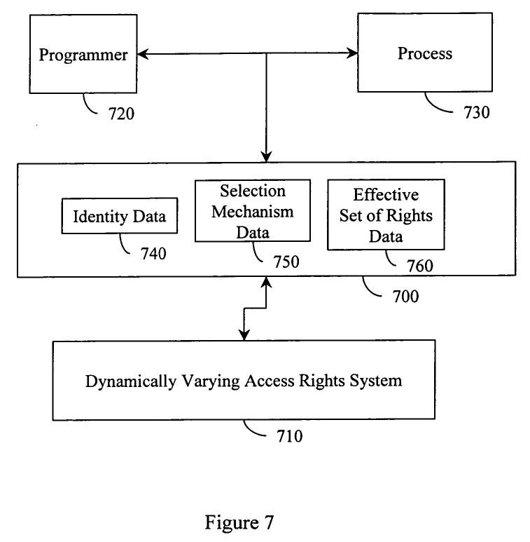

Referring now to FIG. 7, an application programming interface (API) 700 is illustrated providing access to a system 710 for dynamically varying access rights users may assert when interacting with computer resources. The API 700 can be employed, for example, by a programmer 720 and/or a process 730 to gain access to processing performed by system 710. For example, a programmer 720 can write a program to access system 710 (e.g., invoke its operation, monitor its operation, control its operation) where writing the program is facilitated by the presence of the API 700. Rather than programmer 720 having to understand the internals of system 710, the programmer 720 merely has to learn the interface to system 710. This facilitates encapsulating the functionality of system 710 while exposing that functionality.

Similarly, the API 700 can be employed to provide data values to system 710 and/or retrieve data values from system 710. For example, a process 730 that processes user identities can provide user identity data to system 710 via the API 700 by, for example, using a call provided in the API 700. Thus, in one example of the API 700, a set of application programming interfaces can be stored on a computer-readable medium. The interfaces can be employed by a programmer, computer component, logic, and so on, to gain access to a system 710 for dynamically varying access rights users may assert when interacting with computer resources. The interfaces can include, but are not limited to, a first interface 740 that communicates a user identity data, a second interface 750 that communicates a selection mechanism data, and a third interface 760 that communicates an effective set of rights data derived from an authentication space data associated with the user identified by the identity data.

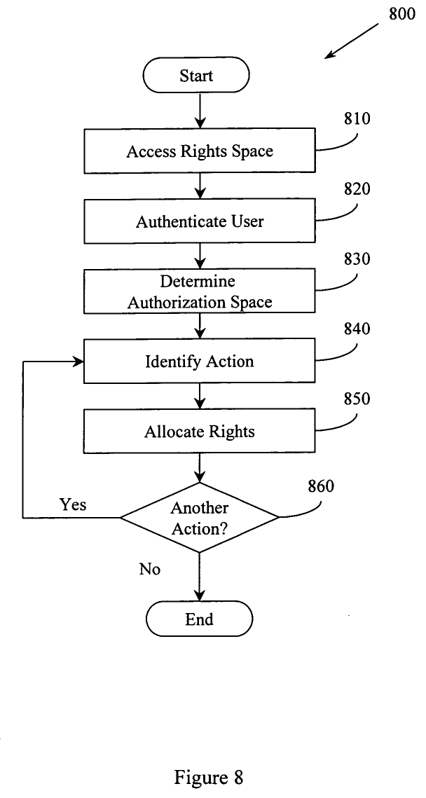

FIG. 8 illustrates an example method 800 associated with varying authorizations defined in a global space based on an operating context without requiring a user to change identities. Method 800 may include, at 810, accessing a rights space. In one example, a rights space may include a set of computer-readable data for characterizing a computer-executable tool configured to interact with access-controlled resources. Method 800 may also include, at 820, authenticating a credentialed user identity.

Method 800 may also include, at 830, summarizing a set of resource accessing rights available to the credentialed user identity. In one example, the set of resource accessing rights may be parsed from the rights space. While parsing is described, it is to be appreciated that resource accessing rights may be derived from the rights space using other techniques.

Method 800 may also include, at 840, identifying an action to be performed by the credentialed user identity, where the action requires a resource accessing right. In one example, an action to be performed by the credentialed user identity determines what type of access mechanism will be employed to build the set of rights available to assert against the resource. The access mechanisms may include, for example, a global access mechanism associated with a sum of rights method for determining a set of rights available to assert during an interaction and a direct access mechanism associated with a subset of rights method for determining the set of rights available to assert during the interaction.

Method 800 may also include, at 850, allocating to the credentialed user identity a subset of rights from the set of resource accessing rights available to the credentialed user identity without re-authenticating the credentialed user identity, where membership in the subset of rights depends, at least in part, on the action to be performed by the credentialed user identity.

While example systems, methods, and so on, have been illustrated by describing examples, and while the examples have been described in considerable detail, it is not the intention of the applicants to restrict or in any way limit the scope of the appended claims to such detail. It is, of course, not possible to describe every conceivable combination of components or methodologies for purposes of describing the systems, methods, and so on, described herein. Additional advantages and modifications will readily appear to those skilled in the art. Therefore, the invention is not limited to the specific details, the representative apparatus, and illustrative examples shown and described. Thus, this application is intended to embrace alterations, modifications, and variations that fall within the scope of the appended claims. Furthermore, the preceding description is not meant to limit the scope of the invention. Rather, the scope of the invention is to be determined by the appended claims and their equivalents.

To the extent that the term “includes” or “including” is employed in the detailed description or the claims, it is intended to be inclusive in a manner similar to the term “comprising” as that term is interpreted when employed as a transitional word in a claim. Furthermore, to the extent that the term “or” is employed in the detailed description or claims (e.g., A or B) it is intended to mean “A or B or both”. When the applicants intend to indicate “only A or B but not both” then the term “only A or B but not both” will be employed. Thus, use of the term “or” herein is the inclusive, and not the exclusive use. See, Bryan A. Garner, A Dictionary of Modern Legal Usage 624 (2d. Ed. 1995).

What is claimed is:

1. A computer-executable method that facilitates dynamically varying access rights users may assert when interacting with computer resources, comprising:
accessing an authenticated identity for a user;
establishing a set of rules that describe a set of interactions the user may have with respect to a set of computer resources;
establishing, from the set of rules, an aggregate set of rights the user has available to assert against the set of computer resources; and
one or more times, on a per interaction basis:
in response to the user selecting a computer-executable tool to interact with a chosen computer resource from the set of computer resources, identifying a rights varying method associated with the selected computer-executable tool; and
applying the rights varying method to the aggregate set of rights to determine which access rights are available to the user for interacting with the chosen computer resource using the selected computer-executable tool.

2. The computer-executable method of claim 1, where the set of rules that describe the set of interactions the user may have with respect to the set of computer resources depends, at least in part, on the identity for the user.

3. The computer-executable method of claim 2, where the aggregate set of rights the user has available to assert against the set of computer resources depends, at least in part, on the identity for the user.

4. The computer-executable method of claim 3, where the rights varying method associated with the selected computer-executable tool is one of, a sum of rights method associated with a global access mechanism related to the selected computer-executable tool, and a subset of rights method associated with a direct access mechanism related to the selected computer-executable tool.

5. The computer-executable method of claim 1, where establishing the set of rules includes storing one or more name-value pairs in one or more XML records, the one or more name-value pairs being configured to identify one or more of, a computer-executable tool, a right associated with a computer-executable tool, and a rights varying method associated with a computer-executable tool.

6. The computer-executable method of claim 5, where establishing the aggregate set of rights includes selecting one or more values from the one or more name-value pairs stored in the one or more XML records, summarizing the one or more values into a set of values, eliminating one or more superceded values from the set of values, and arranging the set of values into one or more second name-value pairs in one or more second XML records.

7. The computer-executable method of claim 6, where applying the rights varying method to the aggregate set of rights to determine which access rights are available to the user for interacting with the chosen computer resource using the selected computer-executable tool includes selecting one or more aggregated values from the one or more second name-value pairs stored in the one or more second XML records, and selectively manipulating one or more of the one or more aggregated values.

8. A computer-readable medium storing processor executable instructions operable to perform a method that facilitates dynamically varying access rights users may assert when interacting with computer resources, the method comprising:
accessing an authenticated identity for a user;
establishing a set of rules that describe a set of interactions the user may have with respect to a set of computer resources;
establishing, from the set of rules, an aggregate set of rights the user has available to assert against the set of computer resources; and
one or more times, on a per interaction basis:
in response to the user selecting a computer-executable tool to interact with a chosen computer resource from the set of computer resources, identifying a rights varying method associated with the selected computer-executable tool; and
applying the rights varying method to the aggregate set of rights to determine which access rights are available to the user for interacting with the chosen computer resource using the selected computer-executable tool.

9. A system that facilitates one authenticated user to assert different sets of access rights during different interactions with computer resources while maintaining a single authenticated identity, comprising:
a first logic configured to access an authenticated user identity;
a second logic configured to create an authorization space comprising a set of rules configured to facilitate defining interactions the user may have with one or more access-controlled resources accessible through a tool characterized in a rights space, the authorization space depending, at least in part, on the authenticated user identity;
a third logic configured to create an aggregate set of rights the user has available to assert against the access-controlled computer resources, the aggregate set of rights being derived from information available in the authorization space; and
a per-interaction logic configured:
to identify a computer-executable tool selected by the user to interact with one or more of the access-controlled computer resources;
to identify a rights varying method associated with the identified computer-executable tool; and
to apply the rights varying method to the aggregate set of rights to determine an effective set of rights for an interaction.

10. The system of claim 9, where the second logic creates the authorization space by storing one or more records configured to record one or more relationships between one or more of, the user, a computer-executable tool, a right, and an access-controlled resource.

11. The system of claim 10, where the third logic creates the aggregate set of rights by retrieving a relationship data from the one or more records, summarizing one or more relationships in the relationship data between one or more of, the user, one or more computer-executable tools, one or more rights, and one or more access-controlled resources, eliminating one or more superfluous relationships in the summarized relationships, and storing one or more second records configured to record the aggregate set of rights.

12. The system of claim 11, where the per-interaction logic applies the rights varying method by retrieving an aggregate rights data from the one or more second records, and selectively manipulates one or more items from the aggregate rights data to create the effective set of rights for an interaction.

13. A system, comprising:
a first logic configured to establish an authorization space for a user based, at least in part, on a user identity;
a second logic configured to identify an access mechanism employed by the user to access a resource; and
an effective rights logic configured:
to establish an effective set of rights for the user based, at least in part, on the access mechanism employed by the user to access the resource, and the authorization space for the user; and
to manipulate the effective set of rights while maintaining the user identity.

14. The system of claim 13, including a rights logic configured to access a rights space from which the authorization space for the user can be established, the rights space comprising a set of data configured to facilitate characterizing a tool that facilitates accessing one or more resources.

15. The system of claim 14, where characterizing a tool includes identifying one or more access mechanisms associated with the tool.

16. The system of claim 14, the rights logic being configured to establish the rights space by storing the set of data as one or more rights records in a data store.

17. The system of claim 16, where a rights record includes a name-value pair arranged in an XML record, the name-value pair being configured to identify one or more of, a tool, a right associated with a tool, and an access method associated with a tool.

18. The system of claim 13, the authorization space comprising a set of rules configured to facilitate defining an action a user may take with respect to a resource accessible through a tool characterized in a rights space.

19. The system of claim 13, the second logic being configured to determine which of, a global access mechanism, and a direct access mechanism the user employed to access the resource.

20. The system of claim 19, where the global access mechanism and the direct access mechanism may be chosen by one or more of, an implicit choice and an explicit choice.

21. The system of claim 19, the global access mechanism being associated with a sum of rights method for determining the effective set of rights and the direct access mechanism being associated with a subset of rights method for determining the effective set of rights.

22. The system of claim 21, the effective rights logic being configured to establish the effective set of rights for the user by applying one of, the sum of rights method, and the subset of rights method to the authorization space.

23. The system of claim 22, the effective rights logic being configured to re-establish the effective set of rights for the user for each access made by the user while maintaining the user identity.

24. A computer-executable method, comprising:
allocating a set of rights to a user based, at least in part, on an authenticated identity for the user;
identifying an action performed by the user, the action being directed to a rights-protected resource accessible through one or more members of a set of tools associated with a rights environment; and
selectively making available to the user, for the purpose of accessing the rights-protected resource, one or more members of the set of rights allocated to the user based, at least in part, on the action performed by the user, while maintaining the authenticated identity for the user.

25. The method of claim 24, including:
establishing the rights environment by storing one or more XML records in a data store.

26. The method of claim 25, the rights environment being configured to facilitate characterizing, at least in part, a tool configured to facilitate user access to a rights-protected resource, where characterizing the tool includes defining a rights-controlling access mechanism associated with the tool.

27. The method of claim 24, where the action performed by the user determines which of, a global access mechanism, and a direct access mechanism is applied to the set of rights allocated to the user to determine which members of the set of rights allocated to the user will be made available to the user.

28. The method of claim 27, where the global access mechanism is associated with a non-restricting method for determining which members of the set of rights allocated to the user will be made available to the user and where the direct access mechanism is associated with a restricting method for determining which members of the set of rights allocated to the user will be made available to the user.

29. The method of claim 27, where one of, the non-restricting method, and the restricting method are applied to the set of rights allocated to the user on a per access basis to determine whether a member of the set of rights allocated to the user is made available to the user for an access to a rights-protected resource.

30. The method of claim 24, including:
one or more times:
identifying a second action performed by the user, the second action being directed to a second rights-protected resource accessible through one or more members of the set of tools associated with the rights environment; and
selectively making available to the user, for the purpose of accessing the second rights-protected resource, one or more members of the set of rights allocated to the user based, at least in part, on the second action performed by the user, and without requiring a re-authenticated identity for the user.

31. A method, comprising:
establishing a rights environment by storing one or more XML records in a data store, the rights environment being configured to facilitate characterizing, at least in part, a tool configured to facilitate user access to a rights-protected resource, where characterizing the tool includes defining a rights-controlling access mechanism associated with the tool;
allocating a set of rights to a user based, at least in part, on an authenticated identity for the user;
identifying an action performed by the user, the action being directed to a rights-protected resource accessible through one or more members of a set of tools associated with the rights environment, where the action performed by the user determines which of, a global access mechanism, and a direct access mechanism is applied to the set of rights allocated to the user to determine which members of the set of rights allocated to the user will be made available to the user, the global access mechanism being associated with a non-restricting method for determining which members of the set of rights allocated to the user will be made available to the user and the direct access mechanism being associated with a restricting method for determining which members of the set of rights allocated to the user will be made available to the user; and
selectively making available to the user, for the purpose of accessing the rights-protected resource, one or more members of the set of rights allocated to the user based, at least in part, on the action performed by the user, while maintaining the authenticated identity for the user, where one of, the non-restricting method, and the restricting method are applied to the set of rights allocated to the user on a per access basis to determine whether a member of the set of rights allocated to the user is made available to the user for an access to a rights-protected resource.

32. A computer-readable medium storing processor executable instructions operable to perform a method, the method comprising:
allocating a set of rights to a user based, at least in part, on an authenticated identity for the user;
identifying an action performed by the user, the action being directed to a rights-protected resource accessible through one or more members of a set of tools associated with a rights environment, where the action performed by the user determines which of, a global access mechanism, and a direct access mechanism is applied to the set of rights allocated to the user to determine which members of the set of rights allocated to the user will be made available to the user; and
selectively making available to the user, for the purpose of accessing the rights-protected resource, one or more members of the set of rights allocated to the user based, at least in part, on the action performed by the user, while maintaining the authenticated identity for the user, where one of, the non-restricting method, and the restricting method are applied to the set of rights allocated to the user on a per access basis to determine whether a member of the set of rights allocated to the user is made available to the user for an access to a rights-protected resource.

33. A system, comprising:
means for accessing an authorization space associated with a credentialed user identity;
means for identifying a context-determining user action performed by the credentialed user identity; and
means for selectively making available to the credentialed user identity a set of access rights applicable to one or more resources associated with the authorization space based, at least in part, on the context-determining user action, where the set of access rights may be varied on a per access basis without requiring a manipulation of the credentialed user identity.

34. A set of application programming interfaces embodied on a computer-readable medium for execution by a computer component in conjunction with dynamically varying access rights users may assert when interacting with computer resources, comprising:
a first interface for communicating a user identity data;
a second interface for communicating a selection mechanism data related to an action taken by a user identified by the user identity data; and
a third interface for communicating an effective set of rights data derived from an authorization space data associated with the user identified by the identity data, where the effective set of rights data is based, at least in part, on the selection mechanism data.

35. A computer-executable resource management tool configured to facilitate dynamically varying, on a per interaction basis, access rights users may assert when interacting with computer resources, comprising:
one or more computer resource accessing tools configured to facilitate performing one or more operations on a computer resource, where a computer resource accessing tool is associated with a rights determining access method;
a user interface configured to facilitate a user selecting one or more of, a computer resource accessing tool, and an action to perform on a computer resource using the selected computer resource accessing tool;
a rights allocating logic configured to allocate a first set of rights to the user based on an authenticated identity for the user; and
a rights varying logic configured to produce a second set of rights from the first set of rights on a per action basis based, at least in part, on the computer resource accessing tool selected to perform the action and the action to be performed using the selected computer resource accessing tool, the rights varying logic being configured to produce the second set of rights without requiring the user to be re-authenticated.

36. The computer-executable resource management tool of claim 35, a computer resource comprising one or more of, a computer system, a computer, a computer component in a computer, and a connection by which two or more resources may be operably connected.

37. The computer-executable resource management tool of claim 36, a computer resource accessing tool comprising one or more of, a resource viewer, a topography viewer, a resource start/stop tool, a resource maintenance tool, and a resource configuration tool.

38. A computer-executable method, comprising:
accessing a rights space;
authenticating a credentialed user identity;
summarizing a set of resource accessing rights available to the credentialed user identity, the set of resource accessing rights being parsed from the rights space;
identifying an action to be performed by the credentialed user identity, where the action requires a resource accessing right; and
allocating to the credentialed user identity a subset of rights from the set of resource accessing rights available to the credentialed user identity without re-authenticating the credentialed user identity, where membership in the subset of rights depends, at least in part, on the action to be performed by the credentialed user identity.

39. The computer-executable method of claim 38, a rights space comprising a set of computer-readable data for characterizing a computer-executable tool configured to access one or more access-controlled resources.

40. The computer-executable method of claim 38, where an action to be performed by the credentialed user identity determines which of, a global access mechanism, and a direct access mechanism the credentialed user identity employed to access an access-controlled resource, where the global access mechanism and the direct access mechanism may be chosen by one or more of, an implicit choice and an explicit choice, and where the global access mechanism is associated with a sum of rights method for determining the subset of rights and the direct access mechanism is associated with a subset of rights method for determining the subset of rights.

41. The computer-executable method of claim 40, where allocating the subset of rights can be repeated on a per action basis for the credentialed user identity.
